(19) United States
(12) Patent Application Publication
(10) Pub. No.: US 2022/0055736 A1
(43) Pub. Date: Feb. 24, 2022

(54) Multi-Function Flap For Aerial Vehicle

(71) Applicant: Sonin Hybrid, LLC, Atlanta, GA (US)

(72) Inventors: Curtis Asa Foster, Lawrenceville, GA (US); Raymond Samuel Trey Davenport, III, Gillsville, GA (US)

(21) Appl. No.: 17/408,859

(22) Filed: Aug. 23, 2021

Related U.S. Application Data
(60) Provisional application No. 63/069,201, filed on Aug. 24, 2020.

(51) Int. Cl. B64C 13/20; B64D 43/00; B64D 47/02; B64C 39/02

(52) U.S. Cl. CPC B64C 13/20; B64C 39/024; B64D 47/02; B64D 43/00

(57) ABSTRACT

An aerial vehicle including a frame, a housing at least partially enclosing the frame, and a flap assembly mounted to at least one of the frame and the housing. The flap assembly can include a flap and an actuator. The aerial vehicle further can include a communication device coupled to the flap. The actuator can be operable to move the flap relative to the housing to at least partially maintain an orientation of the communication device relative to a remote system.

### CROSS-REFERENCE TO RELATED APPLICATIONS

This application claims the benefit of U.S. Provisional Patent Application No. 63/069,201 filed on Aug. 24, 2020.

### INCORPORATION BY REFERENCE

The disclosure of U.S. Provisional Patent Application No. 63/069,201, which was filed on Aug. 24, 2020, is hereby incorporated by reference for all purposes as if presented herein in its entirety.

### TECHNICAL FIELD

The present disclosure relates to features of aerial vehicles, and more particularly, to movable flaps or other features for aerial vehicles. Other aspects also are described.

### SUMMARY

Drones or other unmanned or uncrewed aerial vehicles, are becoming increasingly prevalent in numerous fields (e.g., aerial photography, package delivery, agriculture, surveillance, recreational uses, etc.). Such aerial vehicles can be equipped with GPS components, communication systems, and other technologies that are sensitive to orientation. These components can have an ideal orientation to send and/or receive information from satellites and other communication systems. For drones that operate in various flight positions, the signals and/or functions of these components may become degraded as the drone changes orientations. Accordingly, it can be seen that a need exists for providing aerial vehicles and similar apparatuses with systems that can move communication components and/or other features to at least partially account for vehicle orientation.

In general, one aspect of the disclosure can be directed to an aerial vehicle, such as a drone. The aerial vehicle can include a hybrid aerial vehicle. For example, the aerial vehicle can include a housing, a flap assembly, and a communication device. In one embodiment, the flap assembly can comprise a flap that is movable with respect to the housing, the communication device can be coupled to the flap. In an exemplary embodiment, an actuator can move the flap relative to the housing to at least partially maintain an orientation of the communication device relative to a remote system. Alternatively, or in addition, the actuator can move the flap so that the flap is utilized as a control surface of the aerial vehicle, is utilized as an airbrake, and/or to increase or reduce drag during flight. In one embodiment, a controller can actuate the flap apparatus to move the flap in response to input from one or more orientation sensors located on the flap and/or on another portion of the aerial vehicle. In an exemplary embodiment, the flap apparatus can include a servo or other suitable actuator that is operable to move the flap based on input from a controller.

In another aspect, the disclosure is generally directed to an aerial vehicle that can comprise a frame, a housing at least partially enclosing the frame, and a flap assembly mounted to at least one of the frame and the housing. The flap assembly can comprise a flap and an actuator. The aerial vehicle further can comprise a communication device coupled to the flap. The actuator can be operable to move the flap relative to the housing to at least partially maintain an orientation of the communication device relative to a remote system.

In another aspect, the disclosure is generally directed to a flap assembly for an aerial vehicle. The flap assembly can comprise a flap pivotably mounted to at least one of a frame and a housing of the aerial vehicle, a communication device coupled to the flap, and an actuator that is operable to move the flap relative to the housing to at least partially maintain an orientation of the communication device relative to a remote system.

In another aspect, the disclosure is generally directed to a method that can comprise operating an aerial vehicle comprising a housing, a flap assembly comprising a flap and an actuator, and a communication device coupled to the flap. The method further can comprise moving the aerial vehicle between a first position and a second position and operating the actuator to move the flap relative to the housing to at least partially maintain an orientation of the communication device relative to a remote system during the moving the aerial vehicle between the first position and the second position.

Other aspects, features, and details of the present disclosure can be more completely understood by reference to the following detailed description, taken in conjunction with the drawings and from the appended claims.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. Further, the various features of the drawings discussed below are not necessarily drawn to scale. Dimensions of various features and elements in the drawings may be expanded or reduced to more clearly illustrate the embodiments of the disclosure.

FIGS. 1A-2B schematically show various views and portions of an aerial vehicle or drone and other features according to various embodiments of the disclosure.

FIG. 3 is a schematic view of an aerial vehicle showing at least a portion of a flap assembly with a flap in an extended position according to an exemplary embodiment of the disclosure.

FIG. 4 is a schematic view of some aspects of an aerial vehicle with a flap assembly according to an exemplary embodiment of the disclosure.

FIGS. 5A-5B are views of the flap apparatus according to an exemplary embodiment of the disclosure.

FIG. 6A is a side view of the aerial vehicle of FIG. 3 in a hover, vertical ascent or descent, or landing configuration.

FIG. 6B is a side view of the aerial vehicle of FIGS. 3 and 6A in a forward flight configuration.

Corresponding parts are designated by corresponding reference characters throughout the drawings.

### DETAILED DESCRIPTION

The following description is provided as an enabling teaching of embodiments of this disclosure. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the embodiments of the invention and not in limitation thereof, since the scope of the invention is defined by the claims.

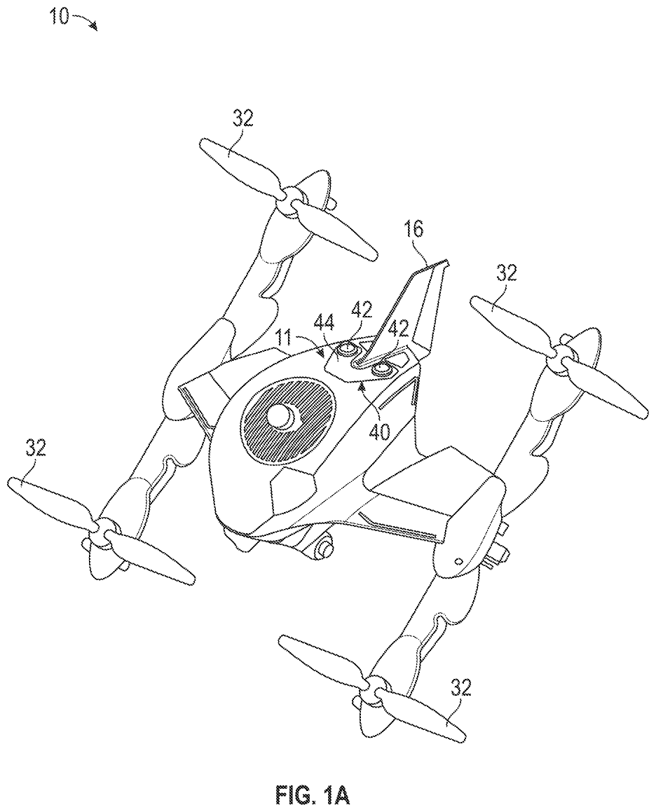

As generally shown in FIGS. 1A and 1B, the present disclosure is directed to an aerial vehicle 10 with a fuselage or housing 11. The aerial vehicle 10 can include a multirotor drone, such as a drone defined by or similar to FAA Part 107 or other similar drones. In embodiments, the housing 11 can be mounted to a frame or chassis 12 (shown schematically in FIGS. 1B-2B), which can be at least partially contained within an interior space 13 of the housing 11. The aerial vehicle 10 also can include a vehicle controller 15 mounted to the chassis 12 at least partially in the interior 13 of the housing 11. In the illustrated embodiments, the interior 13 of the housing 11 can be at least partially defined by an outer wall 14 of the housing 11 (e.g., as schematically shown in FIG. 1B). The vehicle controller 15 can be configured to control operations associated with the aerial vehicle 10, such as propulsion, maneuvering, and operation of various systems of the aerial vehicle 10.

The aerial vehicle 10 further can include one or more electric motors 26 coupled to the chassis 12 and in communication with the vehicle controller 15 and configured to convert electrical power into rotational power. In exemplary embodiments, each of the electric motors 26 can be coupled to one or more propulsion members 32, such as rotors other suitable airfoils (e.g., via a rotating drive shaft). The electric motors 26 can be selectively activated by the vehicle controller 15 to drive rotation of the propulsion members 32 to facilitate lift, maneuvering, etc. of the aerial vehicle 10. While the aerial vehicle 10 shown in FIGS. 1A and 2A is shown as having four electric motors 26 and four propulsion members 32, the aerial vehicle 10 can include any suitable number of electric motors 26 and propulsion members 32, such as six, eight, ten, or more, without departing from the disclosure. The aerial vehicle 10 includes a power source, such as one or more batteries 21 (e.g., Lithium Polymer (Li-Po) batteries, Lithium Iron Phosphate (LFP) batteries, batteries with other general Lithium-Ion chemistries, suitable batteries, and/or other suitable power sources), for providing power to the aerial vehicle 10 including the electric motors 26.

In the illustrated embodiments, the aerial vehicle 10 further can include a vertical stabilizer 16, which can be continuous with and/or integral with the housing 11 or can be a separate component that is mounted to the housing 11 and/or the chassis 12. The vertical stabilizer 16 can help stabilize the aerial vehicle 10 during flight and/or can have other suitable aerodynamic and/or vehicle control features and advantages. In addition, in embodiments, the vertical stabilizer 16 can include an interior space 17 (FIG. 1B).

Although the example aerial vehicle 10 shown in FIG. 1A is a multirotor aerial vehicle, the aerial vehicle 10 may be any known type of aerial vehicle. For example, the aerial vehicle 10 may be a fixed-wing aerial vehicle, a dual-rotor aerial vehicle, a vertical take-off and landing vehicle, an aerial vehicle having fixed-wing and multirotor characteristics, etc. The aerial vehicle 10 may be manually controlled via an on-board pilot, at least partially remotely controlled, semi-autonomously controlled, and/or autonomously controlled. For example, the aerial vehicle 10 may be configured to be manually controlled by an on-board human pilot. In some examples, the aerial vehicle 10 may be configured to receive control signals from a remote location and be remotely controlled via a remotely located human pilot and/or a remotely located computer-based controller.

In some examples, operation of the aerial vehicle 10 may be controlled entirely by remote control or partially by remote control. For example, the aerial vehicle 10 may be configured to be operated remotely during take-off and landing maneuvers, but may be configured to operate semi- or fully-autonomously during maneuvers between take-off and landing. In some examples, the aerial vehicle 10 may be an unmanned or uncrewed aerial vehicle that is autonomously controlled, for example, via the vehicle controller, which may be configured to autonomously control maneuvering of the aerial vehicle 10 during take-off from a departure location, during maneuvering in-flight between the departure location and a destination location, and during landing at the destination location, for example, without the assistance of a remotely located pilot or remotely located computer-based controller, or an on-board pilot.

As shown in FIGS. 1B-2B, the aerial vehicle 10 additionally can include a mechanical power source (e.g., an internal combustion engine 18) coupled to the chassis 12. The aerial vehicle 10 also can include a fuel supply 20 (FIG. 2B), which may include a reservoir for containing fuel and a fuel conduit for providing flow communication between the fuel supply 20 and the internal combustion engine 18 for operation thereof the internal combustion engine 18. The internal combustion engine 18 may include any type of internal combustion engine configured to convert any type of fuel into mechanical power, such as a reciprocating-piston engine, a two-stroke engine, a three-stroke engine, a four-stroke engine, a five-stroke engine, a six-stroke engine, a gas turbine engine, a rotary engine, a compression-ignition engine, a spark-ignition engine, a homogeneous-charge compression ignition engine, and/or any other known type of engine, though other mechanical power sources can be use without departing from the scope of the present disclosure. The fuel supply 20 may include any type of fuel that may be converted into mechanical power, such as gasoline, gasohol, ethanol, diesel fuel, bio-diesel fuel, aviation fuel, jet fuel, hydrogen, liquefied-natural gas, propane, nuclear fuel, and/or any other known type of fuel convertible into mechanical power by the mechanical power source 18. Although only a single internal combustion engine 18 is shown in FIGS. 1B-2B, the aerial vehicle 10 may include more than one, and the multiple internal combustion engines may be of the same type or of different types, and/or may be configured to operate using the same type of fuel or different types of fuel.

The aerial vehicle 10 also can include an electric power generation device (e.g., a generator 24) coupled to the chassis 12 and the internal combustion engine 18 (e.g., via a rotating shaft) and configured to convert at least a portion of mechanical power supplied by the internal combustion engine 18 into electrical power for use by other components and devices of the aerial vehicle 10. The electrical power generation device can be communicatively coupled to the power source 21 to provide power to charge recharge the power source 21 upon operation of the internal combustion engine 18. Accordingly, the internal combustion engine 18 can be activated to charge or recharge the power source during flight and help to prolong or extend the flight range/maximum flying time of the aerial vehicle 10.

In embodiments, the internal combustion engine 18 also can provide mechanical power for a thrust force for the aerial vehicle. For example, as further shown in FIGS. 2A and 2B, the aerial vehicle 10 can include a propulsion member 22 (e.g., a rotor or other suitable airfoil) coupled to the chassis 12 and the internal combustion engine 18 (e.g., via a rotating shaft). The first propulsion member 22 can be coupled to the internal combustion engine 18 for converting at least a portion of the mechanical power supplied by the internal combustion engine 18 into a thrust force. In embodiments, the first propulsion member 22 can be selectively coupled to the internal combustion engine 18 so that a controller can engage the first propulsion member 22 with the internal combustion engine 18 when powering the first propulsion member 22 with the internal combustion engine 18 is beneficial or desired for the operation of the aerial vehicle 10. In embodiments, the first propulsion member 22 is positioned in a central portion of the aerial vehicle 10.

The aerial vehicle 10 can include features and/or functionality that are similar or identical to the aerial vehicle shown and described in co-pending U.S. patent application Ser. No. 17/232,485, filed on Apr. 16, 2021, the disclosure of which is incorporated-by-reference herein.

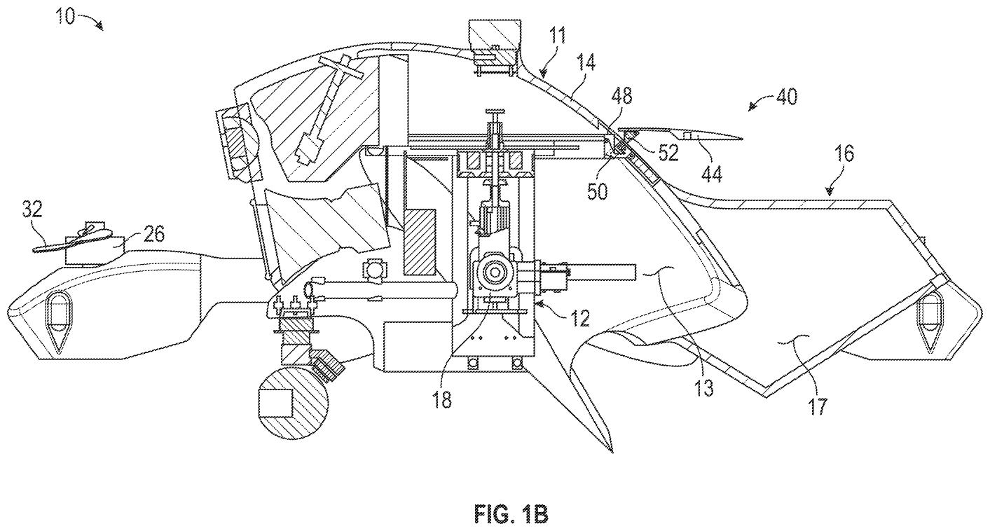

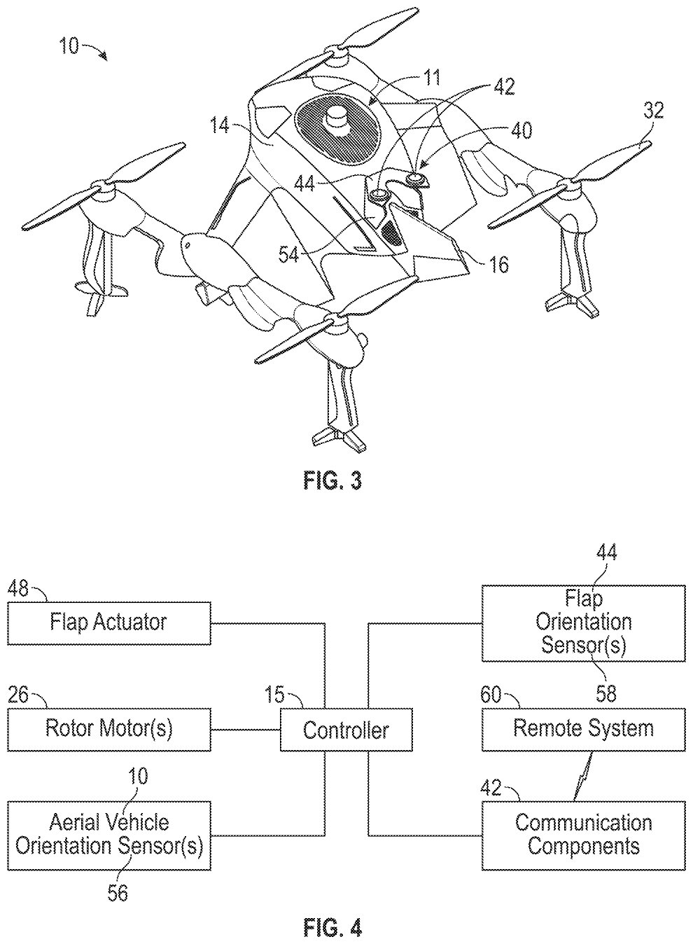

In the illustrated embodiment, the aerial vehicle 10 can include a multi-function flap assembly or system 40 (e.g., FIGS. 1A, 1B, and 3-6B) that can be operated to modify the position of one or more communication devices or components 42 (e.g., FIGS. 3-5B) of the aerial vehicle 10. In exemplary embodiments, the communication devices 42 can include GPS devices (e.g., for receiving GPS data), transmitters (e.g., for sending telemetry data, weather data, audio and/or video data, etc.), receivers (e.g., for receiving control input, commands to execute automated processes, audio for onboard speaker systems, etc.). As schematically shown in FIG. 5B, the flap assembly 40 can include a flap 44 connected to the housing 11 and/or the chassis 12 and movable about an axis or pivot point 46, a servo 48 or other suitable actuator mounted to the housing 11 and/or the chassis 12, and a linkage 50 coupling the servo 48 to the flap 44. In one embodiment, the flap 44 can be mounted on a bracket 52 and the linkage 50 can connect the bracket 52 to a servo horn of the servo 48 for moving the bracket 52 and thereby moving the flap 44. The servo 48 can be operated to move the flap 44 on the bracket 52 about the pivot point 46 to adjust the angle θ (FIG. 5B) of the flap 44 with respect to the outer wall 14 of the housing 11. As shown in at least FIGS. 3 and 5A, a flap pocket 54 can be defined in the outer wall 14 of the housing 11. In the illustrated embodiment, the flap pocket 54 can be a recess in the housing 11 that allows the flap 44 to be retracted into a low aerodynamic drag position for efficiency and flight mode considerations, for example. The flap pocket 54 can be shaped, constructed, or sized to generally correspond to the shape, construction, or size of the flap 44.

As shown in the figures, the communication devices 42 can be mounted along an exterior surface of the flap 44. The flap 44 further can include openings, apertures, or recesses that at least partially receive the communication devices 42 to facilitate coupling thereto, though the communication devices 42 can be connected to the flap 44 using any suitable connections mechanisms or devices. Accordingly, the servo 48 can move the flap 44 to adjust the angle θ in order to position or orient the communication devices 42 into a position relative to the housing 11 in order to facilitate communication between the communication devices 42 and remote systems (e.g., GPS and/or other satellites, other airborne systems, and/or ground-based systems). The flap 44 can be adjusted based on a characteristic of one or more signals of the communication devices 42 (e.g., based on a signal intensity, signal errors, or other signal characteristics).

For example, in some instances, such as when the communication devices 42 are actively communicating back and forth with other, off-board systems, the flap 44 can be positioned to improve a signal intensity as understood by the off-board systems, e.g., as received by an off-drone receiver. In this regard, the flap 44 can be positioned to help the broadcasted signal concentrate its signal on the receiver, without necessarily changing the actual intensity of the broadcasted signal, allowing the signal to arrive with less errors. The flap 44 further can be positioned to find a path for the signal to transmit with less obstructions. Also, less obstruction pathfinding could also be actively choosing between multiple receiver locations and deciding the orientation and receiver accordingly. These benefits all work to improve the communication ability of the communication devices 42, e.g., to help to facilitate more efficient use of the broadcasted signal.

In other uses, such as where the communication devices 42 are receiving information, the flap 44 can be positioned to have a similar effect to an off-drone device boosting its signal. In some variations, the communication devices 42 can be thought of as a “collector” appropriate for some communication technologies that should be facing the transmitter or be oriented in some ideal way to maximize the collection of information from the transmitter.

Adjusting the flap 44 position/orientation can help to boost efficiency of communication, for example, when dealing with obstructions, such as concrete bridges/buildings, mountains, active communication suppressing devices, and in some cases even clouds or other meteorological events/weather related obstructions.

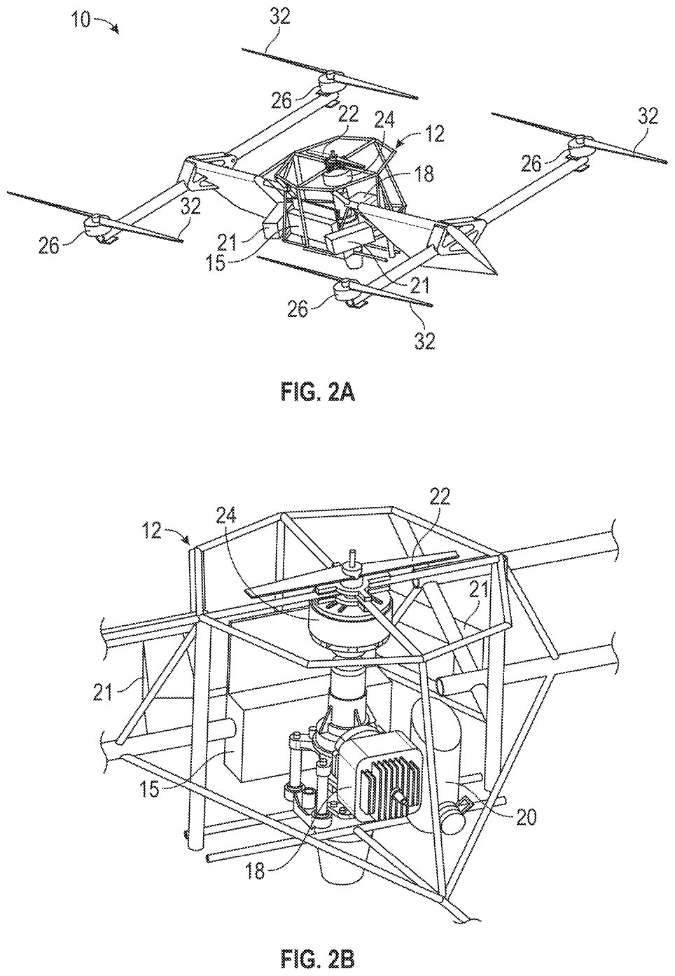

As shown schematically in FIG. 4, the servo 48 can be in communication with the controller 15 to control movement of the flap 44. For example, the controller 15 can generate and provide control signals to the servo 48 for actuation of the servo 48 as needed to change, modify, or adjust the angle θ of the flap 44. In addition, or in the alternative, the aerial vehicle 10 can include another controller(s), control circuitry, etc., in communication with the servo 48 to control movement of the flap 44. In some variations, the other controller can be integrated with the servo 48. In some variations, the controller 15 (or other controller(s)) can receive one or more signals from the communication devices 42, and based on these received signals, the controller 15 can generate and send one or more control signals to the servo 48 to adjust the position of the flap 44 to improve or otherwise change characteristics of signals sent or received by the communication devices 42 (e.g., to increase signal intensity, reduce signal errors, adjusts for obstructions, etc.).

In an exemplary embodiment, the aerial vehicle 10 can include one or more vehicle orientation sensors 56 that are configured to capture information that relates to or indicates a change in the orientation of the aerial vehicle 10. The sensors 56 can be in communication with the controller 15 (or other controller(s)), and the controller 15 (or other controller(s)) can receive one or more signals from the sensors 56. The sensors 56 accordingly can provide one or more signals representative of this captured information to the controller 15 (or other controllers) and, in response thereto and/or based on processing thereof, the controller 15 can actuate the servo 48 to reposition the flap 44 as required (e.g., to maintain an orientation or range of orientations of the communication devices 42). In additional or alternative constructions, one or more optional flap orientation sensors 58 can be mounted on the flap 44 and can send a signal to the controller 15 (or other controller(s)) to indicate positional or orientation information of the flap 44. Accordingly, the controller 15 (or other controller(s)) can actuate the servo 48 based on information from the communication devices 42, vehicle orientation sensor 56, the flap orientation sensor 58, other sensors, and/or combinations thereof. In some embodiments, the orientation sensors 56, 58 could be accelerometers, gyroscopes, and/or any other suitable sensors. Other sensors can include, but are not limited to, load cells for payload or fuel, fuel level sensors, pitot tube or other airspeed/drone speed related sensors, or other, additional sensors collecting information affecting flap angle when using the as an aerodynamic control surface/stability flap/speed brake as discussed below.

In exemplary embodiments, the controller 15 (or other controller(s)) can be configured to facilitate communication between the communication devices 42 and a remote system 60 (e.g., a satellite, aircraft, watercraft, ground-based system, and/or any other suitable system) by at least partially maintaining the orientation of the communication devices 42 relative to the remote system 60 as the aerial vehicle 10 changes orientation (e.g., when reorienting between different flight configurations). Accordingly, the controller 15 (or other controller(s)) can generate one or more signals for actuation of the servo 48 to move the flap 44 as at least a portion of the aerial vehicle 10 changes orientation to at least partially maintain the orientation of the communication devices 42 relative to the remote system 60.

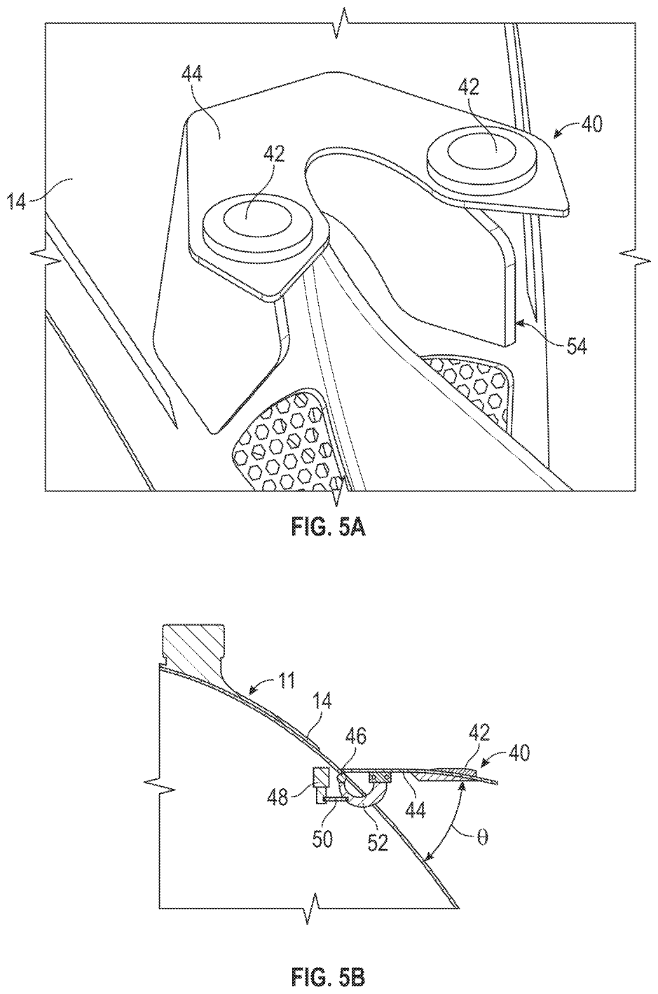

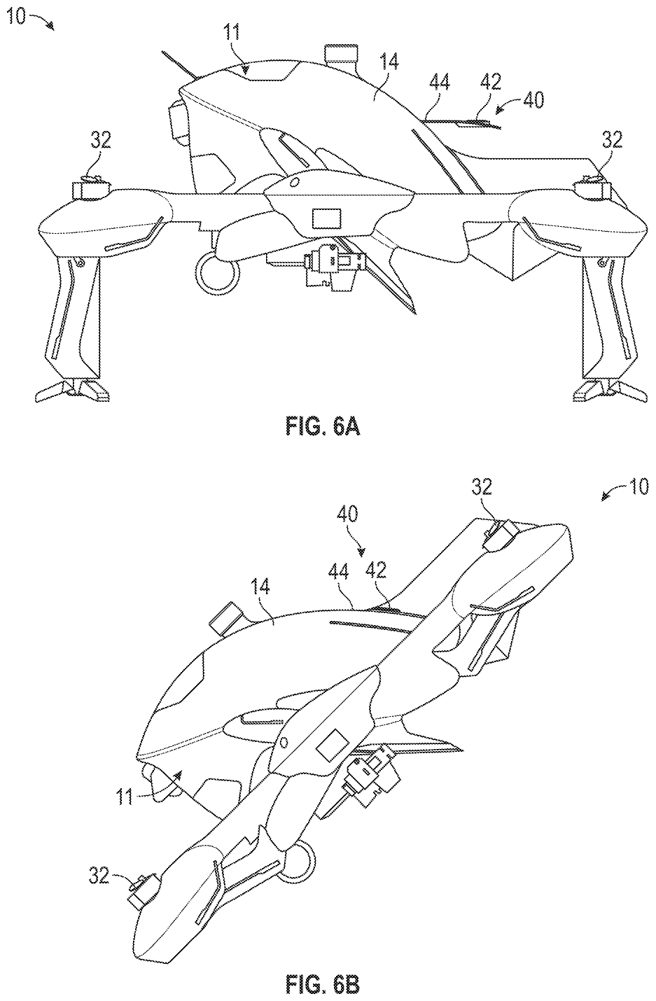

In an example, in the case that the communication devices 42 are in the form of one or more GPS devices or other components that are in communication with an overhead satellite and/or aircraft, it may be desirable or ideal to maintain the orientation of the flap 44 so that the communication devices 42 are facing upward (e.g., the flap 44 is generally horizontal and parallel to the ground). As shown in FIGS. 3-6A, the flap 44 can be extended away from the outer wall 14 of the housing 11 (e.g., in a first flap position relative to the housing 11) when the aerial vehicle 10 is in a first position (e.g., for hovering, landing, vertical ascent, vertical descent, etc.). When the aerial vehicle 10 is moved from the first position to a second position (e.g., a forward flight position) as shown in FIG. 6B, the controller 15 can actuate the servo 48 to move the flap 44 about the pivot point 46 to reduce the angle θ, moving the flap 44 into the flap pocket 54 defined in the outer wall 14 of the housing 11 (e.g., in a second flap position relative to the housing 11). Accordingly, as the housing 11 moves forward from the first position (FIG. 6A) to the second position (FIG. 6B), the servo 48 can move the flap 44 relative to the housing 11 to maintain the upward-facing orientation of the communication devices 42. Stated another way, the servo 48 can be actuated to maintain the flap 44 in the horizontal orientation (e.g., generally, substantially, and/or approximately horizontal orientation) as the housing 11 moves.

The flap assembly 40 could be otherwise constructed, positioned, arranged, and/or configured without departing from the present disclosure. For example, the flap apparatus 40 could be configured to facilitate communication between the communication devices 42 and remote systems 60 that are not overhead (e.g., not directly overhead), such as satellites or aircraft that are not overhead (e.g., the flap 44 could be reoriented to follow a satellite as the aerial vehicle 10 moves relative to the satellite and/or the satellite moves relative to the aerial vehicle) and/or ground-based systems.

In embodiments, the flap assembly 40 also can operate to affect the aerodynamics and/or control of the aerial vehicle 10. For example, the flap 44 can be extended (e.g., as shown in FIG. 5A) to act as an air brake (e.g., during forward flight). Alternatively, or in addition, the flap 44 can be moved to act as a control surface of the aerial vehicle 10 (e.g., for improving stability of, slowing of, etc. the aerial vehicle 10 and/or other factors). The flap apparatus 40 can have additional functions without departing from the disclosure.

In embodiments, the controller 15 (or other controller(s)) can anticipate a change in orientation of the aerial vehicle 10 and can actuate the servo 48 to change the orientation of the flap 44. For example, when changing from the forward flight configuration (FIG. 6B) of the aerial vehicle 10 to the hover configuration (FIG. 6A), the controller 15 (or other controller(s)) can generate one or more signals to actuate the servo 48 to extend the flap 44 before and/or during the transition from the forward flight configuration to the hover configuration. Accordingly, the flap 44 can act as a speed brake and/or control surface to help slow the speed of the aerial vehicle 10 and/or affect the orientation of the aerial vehicle 10 during transition. When the transition to the hover configuration is complete, the flap 44 is already in the extended position for continuing to facilitate communication between the communication devices 42 and the remote system.

In embodiments, the controller 15 (or other controller(s)) can be configured to respond to the detection of an obstruction of the remote system and/or an unexpected decrease in signal strength. For example, the controller 15 can actuate the servo 48 to orient the flap 44 and the communication devices 42 for facilitating communication with different remote systems (e.g., to reorient the communication devices 42 in the form of GPS receivers to receive more signals from GPS satellites that are not obstructed).

In embodiments, the flap assembly 40 can be configured so that the flap 44 has additional degrees of freedom to pivot and/or translate. For example, the flap 44 could pivot along other axes in addition to the pivot point 46 and/or can be translated relative to the housing 11. In an exemplary embodiment, the flap 44 could be orientated about two pivot points to orient the communication devices 42 (e.g., GPS devices) about two axes such that the GPS would be less sensitive to both roll and pitch angle of the drone.

In additional or alternative constructions, the communication devices 42 can be mounted to the flap 44 via actuators that control the orientation of the communication devices 42 in a specific way. For example, the additional actuators could be one or more gimbals with actuators to control each angle along multiple degrees of freedom. This could allow individual GPS devices to target different satellites, for example, and could be configured to also allow the GPS to track satellites even while the aerial vehicle 10 is inverted. In some embodiments, this configuration could allow the flap angle to be controlled with more aerodynamic and control surface considerations in mind while the additional actuators control at least a portion of the orientation of the communication devices 42. In some embodiments, the additional actuators (e.g., one or more gimbals) also could be applied to other locations on the aerial vehicle 10, including a wing, a vertical stabilizer, and other control surfaces.

In other embodiments, the flap 44 may be split into one or more smaller flaps, each having a respective servo or other actuator and angle setting. In embodiments, each of the flaps could function as separate aerodynamic control surfaces and could give the option of using one flap focused on ideal GPS or other communication orientation while the other flap is more free to be controlled for aerodynamic/control surface considerations.

In one embodiment, the flap assembly 40 of the present disclosure can have multiple functions including acting as a control surface and/or airbrake for the aerial vehicle 10 and maintaining a particular orientation for components (e.g., communication devices 42) as the orientation of the aerial vehicle 10 changes. For example, the flap assembly 40 can maintain an upward-facing orientation of a GPS device mounted on the flap 44 as the housing 11 pivots during the change between flight modes of the aerial vehicle 10 (e.g., between the forward flight configuration of FIG. 6B and the hover or landing configuration of FIGS. 3 and 6A). In one embodiment this can be advantageous particularly for an aerial vehicle 10 with significant changes in orientation between flight modes and/or that use sensitive communication devices 42.

Any of the features of the various embodiments of the disclosure can be combined with replaced by, or otherwise configured with other features of other embodiments of the disclosure without departing from the scope of this disclosure. The configurations and combinations of features described above and shown in the figures are included by way of example.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention.

What is claimed is:

1. An aerial vehicle, comprising:
a frame;
a housing at least partially enclosing the frame;
a flap assembly mounted to at least one of the frame and the housing, the flap assembly comprising a flap and an actuator; and
a communication device coupled to the flap, wherein the actuator is operable to move the flap relative to the housing to at least partially maintain an orientation of the communication device relative to a remote system.

2. The aerial vehicle of claim 1, further comprising a controller in communication with the actuator, wherein the controller is configured for signaling the actuator to move the flap relative to the housing.

3. The aerial vehicle of claim 2, wherein the controller is in communication with one or more orientation sensors, and the controller is configured for signaling the actuator to move the flap relative to the housing at least in response to signals from the orientation sensors.

4. The aerial vehicle of claim 3, wherein the one or more orientation sensors comprise vehicle orientation sensors configured to capture information that relates to a change in orientation of the aerial vehicle.

5. The aerial vehicle of claim 2, wherein the controller is in communication with the communication device and is configured for signaling the actuator to move the flap relative to the housing at least in order to improve characteristics of signals sent or received by the communication device.

6. The aerial vehicle of claim 1, wherein the flap is mounted to the at least one of the housing and the fame by a flap bracket, and the actuator comprises a servo connected to the flap bracket by a linkage.

7. The aerial vehicle of claim 1, wherein the aerial vehicle is positionable between at least a first position and a second position, the flap extends away from an outer wall of the housing when the aerial vehicle is in the first position, and the flap is at least partially received in a flap pocket defined in the outer wall of the housing when the aerial vehicle is in the second position.

8. The aerial vehicle of claim 1, wherein the actuator is further operable to move the flap relative to the housing for affecting one or more aerodynamic aspects of the aerial vehicle.

9. A flap assembly for an aerial vehicle, the flap assembly comprising:
a flap pivotably mounted to at least one of a frame and a housing of the aerial vehicle;
a communication device coupled to the flap; and
an actuator that is operable to move the flap relative to the housing to at least partially maintain an orientation of the communication device relative to a remote system.

10. The flap assembly of claim 9, wherein the actuator is in communication with a controller configured for signaling the actuator to move the flap relative to the housing.

11. The flap assembly of claim 10, wherein the controller is configured for signaling the actuator to move the flap relative to the housing at least in response to signals from one or more orientation sensors.

12. The flap assembly of claim 10, wherein the communication device is in communication with the controller, and the controller is configured for signaling the actuator to move the flap relative to the housing at least in order to improve characteristics of the signals sent or received by the communication device.

13. The flap assembly of claim 9, wherein the actuator is further operable to move the flap relative to the housing for affecting one or more aerodynamic aspects of the aerial vehicle.

14. A method comprising:
operating an aerial vehicle comprising a housing, a flap assembly comprising a flap and an actuator, and a communication device coupled to the flap;
moving the aerial vehicle between a first position and a second position; and
operating the actuator to move the flap relative to the housing to at least partially maintain an orientation of the communication device relative to a remote system during the moving the aerial vehicle between the first position and the second position.

15. The method of claim 14, wherein the aerial vehicle comprises a controller in communication with the actuator, and the operating the actuator comprises the controller signaling the actuator to move the flap relative to the housing.

16. The method of claim 15, wherein the controller is in communication with one or more orientation sensors, and the operating the actuator comprises the controller signaling the actuator to move the flap relative to the housing in response to signals from the orientation sensors.

17. The method of claim 15, wherein the controller is in communication with the communication device and the controller signals the actuator to move the flap in response to changes in characteristics of signals sent or received by the communication device.

18. The method of claim 14, wherein the flap is mounted to the at least one of the housing and the fame by a flap bracket, and the actuator comprises a servo connected to the flap bracket by a linkage.

19. The method of claim 14, wherein the operating the actuator to move the flap relative to the housing comprising moving the flap between a first flap position extending away from an outer wall of the housing when the aerial vehicle is in the first position and a second flap position in which the flap is at least partially received in a flap pocket defined in the outer wall of the housing when the aerial vehicle is in the second position.

20. The method of claim 14, further comprising using the flap as a control surface of the aerial vehicle by operating the actuator to move the flap relative to the housing to affect one or more aerodynamic aspects of the aerial vehicle.
